(19) United States
(12) Patent Application Publication
(10) Pub. No.: US 2014/0342668 A1
(43) Pub. Date: Nov. 20, 2014

(54) SMART PHONE CASE

(71) Applicant: Tatsuya Kyomitsu, Wako-shi (JP)

(72) Inventor: Tatsuya Kyomitsu, Wako-shi (JP)

(73) Assignee: HONDA MOTOR CO., LTD., Tokyo (JP)

(21) Appl. No.: 13/895,952

(22) Filed: May 16, 2013

(51) Int. Cl. H04M 1/02

(52) U.S. Cl. CPC H04M 1/026
USPC 455/41.2; 455/575.1

(57) ABSTRACT

Systems and methods that facilitate communication between a smart device and a vehicle are discussed. One such system can include a smart device case that can house the smart device and can include a receptacle. The system can also include a key fob associated with the vehicle that can couple with the receptacle and can establish a communications link with the smart device. Additionally, the system can include mobile application software that can translate one or more user inputs received via the smart phones into a command. The mobile application software can transmit the command to the key fob via the communications link, and the key fob can relays the command to the vehicle in order to control at least one system of the vehicle.

### BACKGROUND

There are a growing number of items that are required to function in today's world, such as a phone, key fob, wallet, etc. However, requiring a person to keep this growing number of items with them can be cumbersome and obtrusive, and keeping track of so many items can lead to problems such as misplaced or lost items.

Recent advances in technology have enabled some reduction in the number of devices. Smart phones are becoming increasingly versatile and ubiquitous fixtures of modern life. For example, smart phones have been combined with the capabilities of a wallet in mobile wallet apps, providing the ability to make transactions simply via the phone. However, combining a smart phone with a key fob has multiple potential problems, such as security, communication mode, and the fact that users frequently upgrade smart phones every two years, leading to complications related to updating or replacing the hardware.

### SUMMARY

The following presents a simplified summary of the disclosure in order to provide a basic understanding of certain aspects of the disclosure. This summary is not an extensive overview of the disclosure. It is not intended to identify key/critical elements of the disclosure or to delineate the scope of the disclosure. Its sole purpose is to present certain concepts of the disclosure in a simplified form as a prelude to the more detailed description that is presented later.

The disclosure disclosed and claimed herein, in one aspect thereof, includes systems and methods that facilitate communication between a user device and a vehicle are discussed. One such system can include a device case that can house the user device and can include a receptacle. The system can also include a key fob associated with the vehicle that can couple with the receptacle and can establish a communications link with the user device. Additionally, the system can include mobile application software that can translate one or more user inputs received via the user device into a command. The mobile application software can transmit the command to the key fob via the communications link, and the key fob can relays the command to the vehicle in order to control at least one system of the vehicle.

In another aspect, the disclosure can include methods of facilitating communication between a user device and a vehicle. One example method can include the acts of housing the user device in a device case that includes a receptacle and coupling a key fob (e.g., one associated with the vehicle, etc.) with the receptacle. Such a method can also include the acts of establishing a communications link between the user device and the key fob, receiving one or more user inputs, translating the one or more user inputs into a command, transmitting the command to the key fob, and relaying the command from the key fob to the vehicle to control at least one system of the vehicle.

To the accomplishment of the foregoing and related ends, certain illustrative aspects of the disclosure are described herein in connection with the following description and the annexed drawings. These aspects are indicative, however, of but a few of the various ways in which the principles of the disclosure can be employed and the disclosure is intended to include all such aspects and their equivalents. Other advantages and novel features of the disclosure will become apparent from the following detailed description of the disclosure when considered in conjunction with the drawings.

### BRIEF DESCRIPTION OF THE DRAWINGS

FIG. 1 illustrates a system that can facilitate interaction between a user device and a vehicle in accordance with one or more aspects of the disclosure.

FIG. 2 illustrates a method of facilitating interactions between the user device and the vehicle in accordance with one or more aspects of the disclosure.

FIG. 3 illustrates a computer-readable medium or computer-readable device including processor-executable instructions configured to embody one or more of the provisions set forth herein, according to one or more aspects of the disclosure.

FIG. 4 illustrates a computing environment where one or more of the provisions set forth herein can be implemented, according to one or more aspects of the disclosure.

### DETAILED DESCRIPTION

The disclosure is now described with reference to the drawings, wherein like reference numerals are used to refer to like elements throughout. In the following description, for purposes of explanation, numerous specific details are set forth in order to provide a thorough understanding of the disclosure. It may be evident, however, that the disclosure can be practiced without these specific details. In other instances, well-known structures and devices are shown in block diagram form in order to facilitate describing the disclosure.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

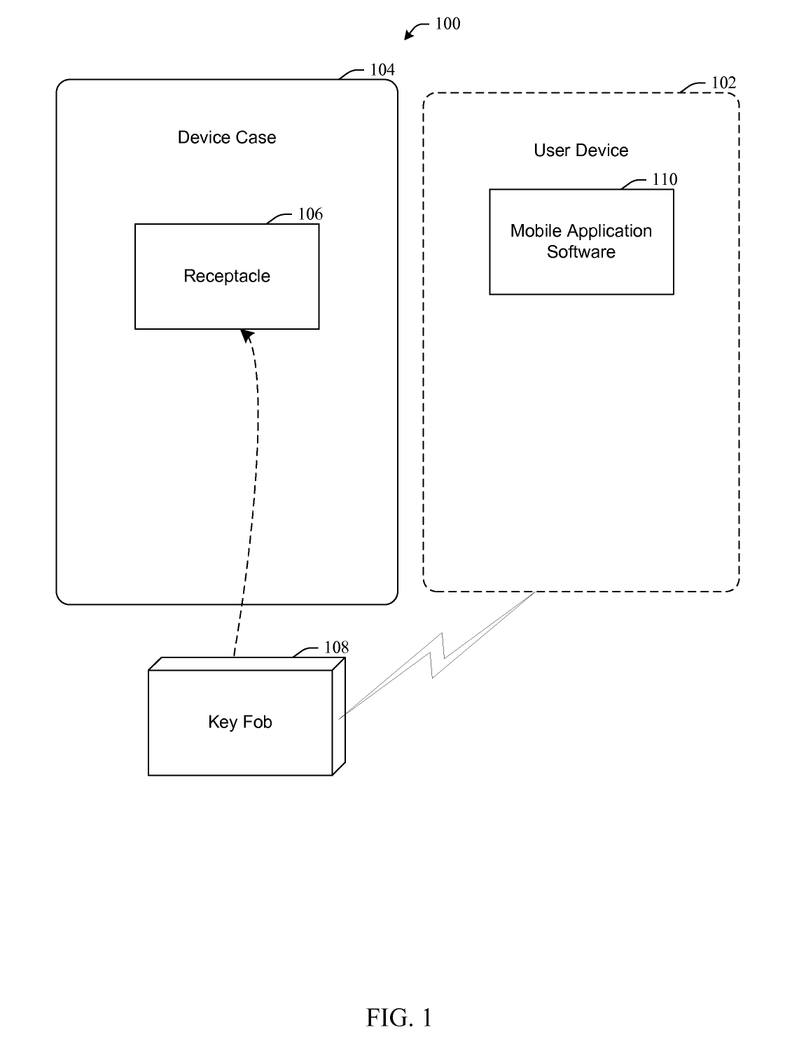

Referring to the drawings, FIG. 1 illustrates a system 100 that can facilitate interaction between a user device 102 and a vehicle (not shown), in accordance with aspects of the disclosure. Although user device 102 will be a smart phone for many users of system 100, user device 102 can be substantially any user device, for example, a smart device, which can include, for example, tablets (e.g. Kindle®, Nook®, Galaxy Note®, iPad®, etc.), cellular/smart phones or PDAs (e.g., Android®, iPhone®, Blackberry®, Palm®, etc.), etc. The system can include a device case 104 that can house the user device 102 and can include a receptacle 106 (which as used herein, can include one or more of a storage location, port, docking station, etc.) that a key fob 108 can be coupled with. Although referred to herein as a “device case,” it is to be appreciated that device case 104 can include substantially any article capable of performing the functions of device case 104, and can include, for example, cases capable of housing user device 102, cases capable of housing user device 102 as well as storing other items (e.g., credit cards and other items, etc.), or other articles that can house user device 102 and can include a receptacle 106.

Key fob 108 can establish a communications link (e.g., near field communication (NFC), Wi-Fi, Bluetooth, etc.), with user device 102 as described herein, and can transmit or relay any of a plurality of commands to the vehicle, each of which can control (e.g., activate, deactivate, adjust settings of, etc.) a system or function associated with the vehicle. These commands can include commands for which key fobs have conventionally been used, such as locking or unlocking doors, unlocking or opening trunks, activating panic alarms, enabling keyless or “push-button” activation of the vehicle (e.g., based on proximity of the key fob 108 to the vehicle, etc.), etc. Additionally, key fob 108 can transmit or relay a variety of other commands, for example, turning the car on or off (e.g., via remote activation of the ignition system, etc.), or controlling other vehicle systems or functions, such as climate control, lights or lighting systems, media systems (e.g., stereo, DVD or other media player, etc.), vehicle navigation systems, infotainment system, etc.

Key fob 108 can include one or more manual controls (e.g., buttons, switches, etc.) to trigger transmission of one or more of the plurality of commands. In other aspects, key fob 108 need not include any manual controls, and transmission of commands can be triggered as described elsewhere herein, with key fob 108 relaying commands received from user device 102. In aspects, key fob 108 can have a reduced sized as compared with conventional key fobs, either via omission of manual controls entirely, or via inclusion of manual controls of reduced size or quantity, as manual controls need not be the only or even primary way of transmitting commands to the vehicle. In certain aspects in which key fob 108 does include manual controls, these manual controls can be disabled or inaccessible (e.g., to prevent accidental use, etc.) while key fob 108 is coupled with receptacle 106.

In aspects of the disclosure, a variety of different device cases 104 can be designed (e.g., based on varying dimensions or characteristics of different user devices 102, based on aesthetic or functional characteristics, etc.), wherein each can have a receptacle 106 that can couple with key fob 108. Thus, in the event device case 104 needs to be replaced—for example, due to user upgrade (e.g., replacement, etc.) of user device 102, due to damage to device case 104, etc.—the replacement device case 104 can also include a receptacle 106 that can couple with the (unchanged) key fob 108. In the same or other aspects of the disclosure, different instances of key fob 108 can have the same or a substantially similar size and shape to one another, such that if key fob 108 needs to be replaced—e.g., the user changes vehicles temporarily or permanently, due to damage to key fob 108—the replacement key fob 108 can couple with the (unchanged or changed, depending on the situation and embodiment) device case 104. For example, a user can use a first key fob 108 associated with a first vehicle (e.g., owned by the user, etc.), temporarily remove the first key fob 108 from receptacle 106 and replace it with a second key fob 108 to operate a second vehicle (e.g., rented by the user, etc.), and then later replace the second key fob 108 with the first key fob 108 to operate the first vehicle again.

System 100 can also include mobile application software 110 that a user associated with user device 102 can install on user device 102, which can facilitate communication between user device 102 and key fob 108, which can then transmit one or more commands to the vehicle. User inputs to user device 102 can be received by mobile application software 110, which can translate these user inputs to commands and send the commands to key fob 108 (e.g., via user device 102 along a communications link between user device 102 and key fob 108, etc.), which can relay these commands to the vehicle. Thus, users of system 100 can have the ease of use and range of controls that would be available if user device 102 were useable to directly control vehicle functions and systems, while having the security advantages of a key fob 108 that is uniquely associated with the vehicle (or one of a small number of key fobs, e.g., two, three, etc. with which the vehicle is specifically associated, etc.).

In one or more aspects, key fob 108 can be a universal key fob that can be coupled with two or more specific vehicles (e.g., sequentially, simultaneously, etc.), which can be based at least in part on data received from user device 102, which can receive an access key that can be transmitted to key fob. For example, if a user wishes to access a vehicle they have not previously accessed, user device 102 can transmit a request (e.g., via mobile application software 110, etc.) for an access key to that vehicle. If the request is approved (e.g., which can depend upon authentication, for example, to ensure that the user associated with user device 102 is authorized to access the vehicle, etc.), then an access key can be transmitted to and received by user device 102. Commands that are transmitted by user device 102 can be accompanied by the access key, and these commands and the access key can be relayed to the vehicle by key fob 108 to control functions or systems (e.g., opening doors, etc.) associated with that vehicle.

Additionally, these access keys can be employed in multiple other ways in connection with the disclosure. For example, mobile application software 110 can maintain the access keys for vehicles that the user can access, and can provide options to change the access key to be transmitted along with commands, thereby allowing a user to easily switch between multiple vehicles that the key fob 108 can be associated with. In another example, access keys can be associated with one or more different sets of rights or privileges, such that a first user (e.g., the owner of the vehicle, etc.) can access the vehicle via the access key, can authorize or deauthorize other users to use the access key, etc.; while a second user (e.g., someone who borrows or rents the vehicle, a teenage child, etc.) can access the vehicle with the access key (although the second user can be deauthorized, etc.), but cannot authorize or deauthorize other users, etc. In a further example, user rights to an access key can be conditional or can be time-based, such that a user who rents a vehicle can use an access key associated with that vehicle during a rental period (and possibly some period of time thereafter, e.g., to allow late return, etc.), but would not be able to access the vehicle after that rental period.

One advantage of the disclosure over conventional key fobs is the ability to receive a wider range of user inputs that can be used to ultimately control vehicle systems or functions, because of the manner in which inputs to user device 102 can be used as described herein. For example, touch screens can provide for selection of a wide range of commands and options, which can be organized in a more user-friendly manner (e.g., menu-based, user customizable, etc.). Voice input can be used to control vehicle systems and functions by name, function, or otherwise (e.g., “open,” “unlock doors,” “open trunk,” “change temperature to 70 degrees,” etc.). Motion inputs (through motion of user device 102, e.g., shaking or tapping it, or through motion detected by user device 102, e.g., waving a hand in front of a camera, etc.) can be associated with various commands, e.g., by default or based on user preference. As but a few non-limiting examples, shaking user device 102 could transmit a command to start the engine, acceleration detected by tapping a leg twice when user device 102 is in that pocket could unlock the doors, bumping user device 102 (or device case 104) against a hard surface such as the vehicle can open the trunk, waving a hand in front of a camera of user device 102 can cause a stereo system to skip to the next track or file, etc. Text-based input can be received from a physical or soft (e.g., virtual) keyboard, providing another input option for users.

Mobile application software 110 can interface with other applications stored on or other capabilities of user device 102, to provide additional capabilities. For example, user preferences can be set such that user device 102 can transmit a command automatically in certain circumstances, such as to turn off a stereo system automatically upon receiving a telephone call, and turn the stereo system back on automatically upon the call ending, or to provide the user with other information, such as appointments, reminders, text messages from designated persons (e.g., via a text-to-speech system, etc.). As another example, the vehicle navigation system can determine a route based on address information from an address book or other source stored on or accessible via the user device 102, such as in response to a user request, calendar entry, etc. In a further example, upon activation of the vehicle, one or more automatic commands can be transmitted, such as to control a media player or stereo system, to control a climate control system, etc.

In various aspects, mobile application software 110 can store a set of user preferences or settings. These user preferences or settings can include one or more access keys for transmitting commands to specific vehicles; preferences or settings related to user inputs (e.g., associating one or more inputs (such as motion inputs, etc.) with one or more commands to be relayed to the vehicle, etc.); automatic commands (e.g., situations in which automatic commands can be triggered, which commands will be triggered, etc.); settings or preferences related to the vehicle, such as climate control settings, stereo system pre-sets (e.g., radio stations, other audio preferences, etc.), etc.; as well as other settings or preferences.

By maintaining such settings and preferences via mobile application software 110, which can stored on user device 102, these settings and preferences can follow the user even when switching vehicles. In an example based on an alternate embodiment, if a user of a first vehicle useable in conjunction with system 100 flies to another city and rents a second vehicle useable in conjunction with system 100, the user can simply remove a first key fob 108 (associated with the first vehicle) from the device case 104 associated with user device 102, and replace it with a second key fob 108 (associated with the second vehicle). The user would thereby be able to use the second vehicle with the user's own preferences or settings.

In various aspects of the disclosure, at least a portion of the data maintained by or associated with mobile application software 110 can be stored (additionally or alternatively) remotely from user device 102, such as on one or more remote servers (e.g., in “the cloud,” etc.). In one or more embodiments, this data can be associated with a user account or other identifying information such that the data can be accessible to the user separately from user device 102. In these or other embodiments, the remotely maintained data can be provided to user device 102 upon certain conditions, e.g., signing into the user account, based on associating the data with an identifier of the user device 102 (e.g., phone number, etc.). Thus, user device 102 can be replaced with a different user device 102 associated with the same user (e.g., due to a periodic (e.g., biannual, etc.) device upgrade, replacement of a lost or damaged device, etc.), and data maintained or associated with mobile application software 110 (e.g., access keys, other settings and preferences, etc.) can thereby be retrieved and associated with user device 102, allowing for reuse of previously maintained settings, preferences, or other data.

User device 102 can be communicatively coupled with key fob 108 via a variety of communication protocols (e.g., near field communication (NFC), Wi-Fi, Bluetooth, etc.). In aspects, they can be coupled via a protocol with a relatively short range, such that user device 102 is only communicatively coupled with key fob 108 (e.g., via establishing an NFC link, etc.) when in very close proximity, for example, when key fob 108 is coupled with receptacle 106 of device case 104.

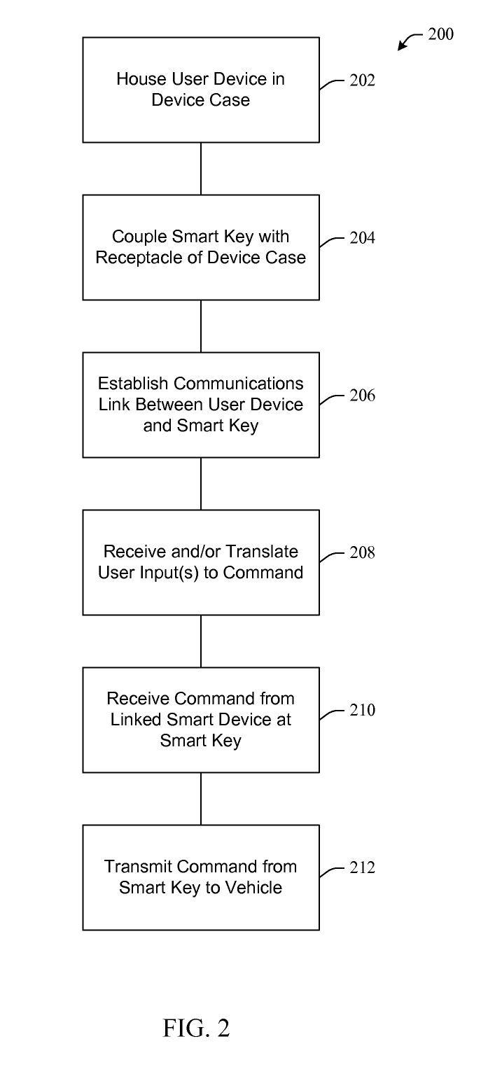

FIG. 2 illustrates a method 200 of facilitating interaction between a user device and a vehicle, in accordance with aspects of the disclosure. While, for purposes of simplicity of explanation, the one or more methodologies shown herein, e.g., in the form of a flow chart, are shown and described as a series of acts, it is to be understood and appreciated that the disclosure is not limited by the order of acts, as one or more acts may, in accordance with the disclosure, occur in a different order and/or concurrently with other acts from that shown and described herein. A methodology could alternatively be represented as a series of interrelated states or events, such as in a state diagram. Moreover, not all illustrated acts may be required to implement a methodology in accordance with the disclosure.

Method 200 can begin at 202 by housing the user device in a device case, such as one described in aspects of the disclosure. At 204, a key fob associated with the vehicle can be coupled with a receptacle of the device case. Then, in act 206, a communications link (e.g., NFC, etc.) can be established between the user device and the key fob. At 208, one or more user inputs (e.g., voice, text, touch, motion, etc.) received at the user device can be translated into vehicle commands, such as via a mobile application software as described herein. In other embodiments, commands can be relayed not based on user inputs, but in response to one or more detected events or conditions as described herein (e.g., receiving a phone call, starting up the vehicle, etc.), while in further embodiments, commands can be relayed based on a combination of user inputs and detected events or conditions. At 210, the command can be transmitted from the user device and received at the key fob via the established communications link. Finally, at 212, the command can be transmitted from the key fob to the vehicle.

In various embodiments, the vehicle can only implement commands received from the key fob associated with the vehicle, to provide increased security as compared with systems in which a user device can issue commands directly to the vehicle without using the key fob as an intermediary. Thus, inclusion of the key fob can restrict unauthorized access to the vehicle, while inclusion of the user device can provide flexibility and ease of use in issuing commands. A device case as described herein can restrict access to the key fob to the user device housed in or associated with the device case, further increasing security, while simultaneously minimizing the number of separate items the user needs to keep with them.

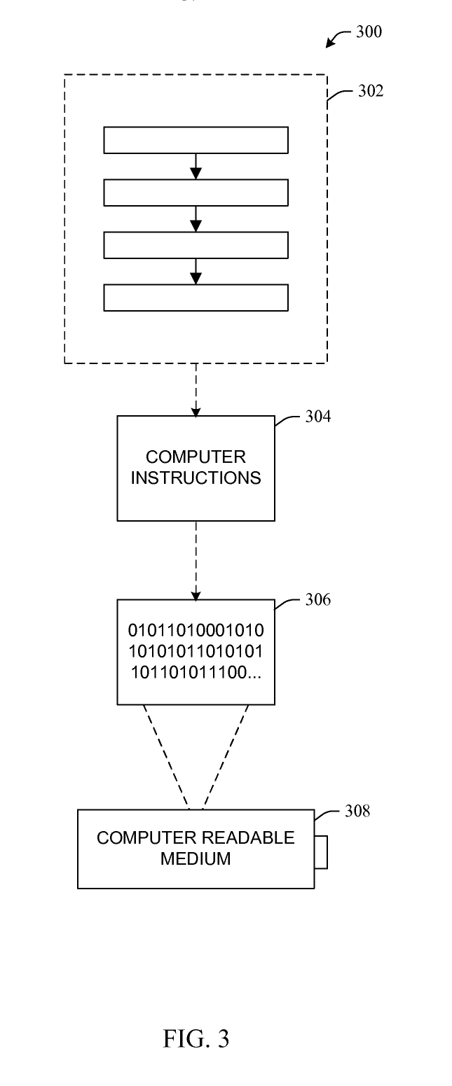

Still another embodiment can involve a computer-readable medium including processor-executable instructions configured to implement one or more embodiments of the techniques presented herein. An embodiment of a computer-readable medium or a computer-readable device that is devised in these ways is illustrated in FIG. 3, wherein an implementation 300 includes a computer-readable medium 308, such as a CD-R, DVD-R, flash drive, a platter of a hard disk drive, etc., on which is encoded computer-readable data 306. This computer-readable data 306, such as binary data including a plurality of zero's and one's as shown in 306, in turn includes a set of computer instructions 304 configured to operate according to one or more of the principles set forth herein. In one such embodiment 300, the processor-executable computer instructions 304 is configured to perform a method 302, such as at least a portion of one or more of the methods described in connection with embodiments disclosed herein. In another embodiment, the processor-executable instructions 304 are configured to implement a system, such as at least a portion of one or more of the systems described in connection with embodiments disclosed herein. Many such computer-readable media can be devised by those of ordinary skill in the art that are configured to operate in accordance with the techniques presented herein.

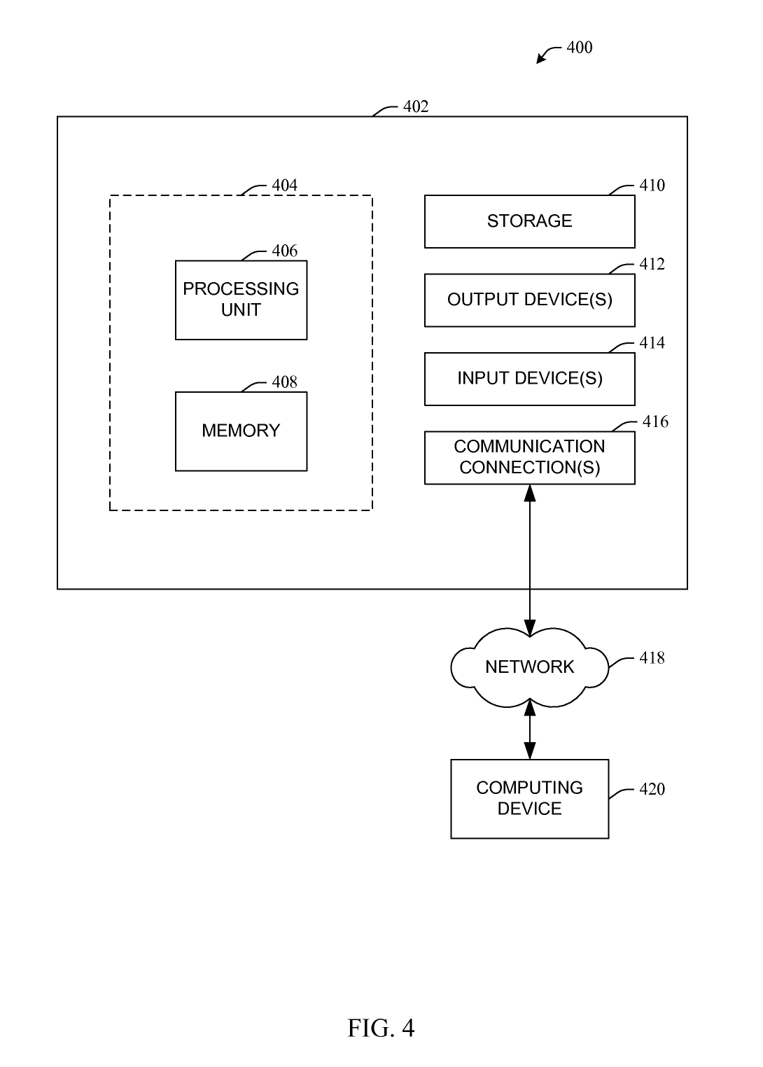

FIG. 4 and the following discussion provide a description of a suitable computing environment in which embodiments of one or more of the provisions set forth herein can be implemented. The operating environment of FIG. 4 is only one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, tablets, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions can be implemented as program modules, such as functions, objects, Application Programming Interfaces (APIs), data structures, and the like, that perform particular tasks or implement particular abstract data types. Typically, the functionality of the computer readable instructions can be combined or distributed as desired in various environments.

FIG. 4 illustrates a system 400 including a computing device 402 configured to implement one or more embodiments provided herein. In one configuration, computing device 42 can include at least one processing unit 406 and memory 408. Depending on the exact configuration and type of computing device, memory 408 may be volatile, such as RAM, non-volatile, such as ROM, flash memory, etc., or a combination of the two. This configuration is illustrated in FIG. 4 by dashed line 404.

In these or other embodiments, device 402 can include additional features or functionality. For example, device 402 can also include additional storage such as removable storage or non-removable storage, including, but not limited to, magnetic storage, optical storage, and the like. Such additional storage is illustrated in FIG. 4 by storage 410. In certain embodiments, computer readable instructions to implement one or more embodiments provided herein are in storage 410. Storage 410 can also store other computer readable instructions to implement an operating system, an application program, and the like. Computer readable instructions can be loaded in memory 408 for execution by processing unit 406, for example.

The term “computer readable media” as used herein includes computer storage media. Computer storage media includes volatile and nonvolatile, removable and non-removable media implemented in any method or technology for storage of information such as computer readable instructions or other data. Memory 408 and storage 410 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 402. Any such computer storage media can be part of device 402.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 402 can include one or more input devices 414 such as keyboard, mouse, pen, voice input device, touch input device, infrared cameras, video input devices, or any other input device. One or more output devices 412 such as one or more displays, speakers, printers, or any other output device can also be included in device 402. The one or more input devices 414 and/or one or more output devices 412 can be connected to device 402 via a wired connection, wireless connection, or any combination thereof. In certain embodiments, one or more input devices or output devices from another computing device can be used as input device(s) 414 or output device(s) 412 for computing device 402. Device 402 can also include one or more communication connections 416 that can facilitate communications with one or more other devices 420 by means of a communications network 418, which can be wired, wireless, or any combination thereof, and can include ad hoc networks, intranets, the Internet, or substantially any other communications network that can allow device 402 to communicate with at least one other computing device 420.

What has been described above includes examples of the disclosure. It is, of course, not possible to describe every conceivable combination of components or methodologies for purposes of describing the disclosure, but one of ordinary skill in the art may recognize that many further combinations and permutations of the disclosure are possible. Accordingly, the disclosure is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates communication between a user device and a vehicle, comprising:
a device case that houses the user device, wherein the device case has a receptacle;
a key fob associated with the vehicle that couples with the receptacle, wherein the key fob establishes a communications link with the user device; and
a mobile application software that translates at least one input received via the user device into a command, wherein the mobile application software transmits the command to the key fob via the communications link,
wherein the key fob relays the command to the vehicle, wherein the command controls at least one system of the vehicle.

2. The system of claim 1, wherein the at least one input comprises a voice input, a motion input, a touch input, or a text input.

3. The system of claim 1, wherein the communications link comprises a near field communication link.

4. The system of claim 1, wherein the user device is a smart phone.

5. The system of claim 1, wherein the mobile application software translates the at least one input based on at least one user setting.

6. The system of claim 1, wherein the command controls at least a climate control system of the vehicle.

7. The system of claim 1, wherein the command controls at least a set of lights associated with the vehicle.

8. The system of claim 1, wherein the command controls at least a media system of the vehicle.

9. The system of claim 1, wherein the mobile application software translates the at least one input into the command based on data associated with a second application of the smart device.

10. The system of claim 1, wherein the mobile application software is associated with a user account that maintains a plurality of user settings.

11. A method of facilitating communication between a user device and a vehicle, comprising:
housing the user device in a device case that comprises a receptacle;
coupling a key fob with the receptacle, wherein the key fob is associated with the vehicle;
establishing a communications link between the user device and the key fob;
receiving at least one input;
translating the at least one input into a command;
transmitting the command to the key fob; and
relaying the command from the key fob to the vehicle to control at least one system of the vehicle.

12. The method of claim 11, wherein receiving the at least one input comprises receiving a voice input, a motion input, a touch input, or a text input.

13. The method of claim 11, wherein establishing the communications link comprises establishing a near field communication link.

14. The method of claim 11, wherein translating the at least one input is based on one or more user settings.

15. The method of claim 11, wherein relaying the command comprises controlling at least a climate control system of the vehicle.

16. The method of claim 11, wherein relaying the command comprises controlling at least a set of lights of the vehicle.

17. The method of claim 11, wherein relaying the command comprises controlling at least a media system of the vehicle.

18. The method of claim 11, wherein translating the at least one input into the command is based on data associated with a second application of the smart device.

19. The method of claim 11, wherein relaying the command comprises controlling at least an ignition system of the vehicle.

20. A system that facilitates communication between a user device and a vehicle, comprising:
means for housing the user device;
means for establishing a communications link with the smart device, wherein the means for establishing a communications link are coupled with the means for housing; and
means for translating at least one input received via the smart device into a command, wherein the means for translating transmits the command to the means for establishing,
wherein the means for establishing relays the command to the vehicle to control at least one system of the vehicle.
